(19) United States
(12) Patent Application Publication
(10) Pub. No.: US 2023/0199426 A1
(43) Pub. Date: Jun. 22, 2023

(54) AUDIO SIGNAL OUTPUT METHOD, AUDIO SIGNAL OUTPUT DEVICE, AND AUDIO SYSTEM

(71) Applicant: YAMAHA CORPORATION, Hamamatsu-shi (JP)

(72) Inventor: Akihiko SUYAMA, Hamamatsu-shi (JP)

(21) Appl. No.: 18/058,947

(22) Filed: Nov. 28, 2022

(30) Foreign Application Priority Data
Dec. 22, 2021 (JP) 2021-208285

(51) Int. Cl. H04S 7/00; H04S 3/00; H04R 5/02; H04R 5/04; G06F 3/16; H04R 5/033

(52) U.S. Cl. CPC H04S 7/304; H04S 3/006; H04R 5/02; H04R 5/04; G06F 3/165; H04R 5/033; H04S 2400/01; H04S 2400/05; H04S 2400/11; H04S 2420/01

(57) ABSTRACT

An audio signal output method is provided. The audio signal output method includes acquiring audio data including a plurality of audio signals corresponding respectively to a plurality of channels, applying a head-related transfer function, which localizes a sound image to a location determined for each of the plurality of channels to each of the plurality of audio signals, outputting first audio signals that have been applied with the head-related transfer functions, among the plurality of audio signals, to an earphone, and outputting the audio signal of one channel corresponding to a location that is in front of a top of a listener's head, among the plurality of audio signals, to a speaker.

### CROSS-REFERENCE TO RELATED APPLICATIONS

This application is based on and claims priority under 35 USC 119 from Japanese Patent Application No. 2021-208285 filed on Dec. 22, 2021, the contents of which are incorporated herein by reference.

### TECHNICAL FIELD

One embodiment of the present invention relates to an audio signal output method, an audio signal output device, and an audio system that output an audio signal.

### BACKGROUND ART

In the related art, there is an audio signal processing device that performs sound image localization processing for localizing a sound image of a sound source at a predetermined location using a plurality of speakers (see, for example, Patent Literature 1). Such an audio signal processing device performs the sound image localization processing by imparting a predetermined gain and a predetermined delay time to an audio signal and distributing the audio signal to a plurality of speakers. The sound image localization processing is also used for earphones. In earphones, sound image localization processing using a head-related transfer function is performed.

### CITATION LIST

### Patent Literature

Patent Literature 1: WO2020/195568

### SUMMARY OF INVENTION

When using earphones, there are directions in which it is difficult for a listener to localize a sound image, and improvement of sound image localization is desired.

An object of the embodiment of the present invention is to provide an audio signal output method for improving sound image localization in the directions in which it is difficult for the listener to localize the sound image when using earphones.

An audio signal output method according to the embodiment of the present invention includes acquiring audio data including a plurality of audio signals corresponding respectively to a plurality of channels; applying a head-related transfer function, which localizes a sound image to a location determined for each of the plurality of channels to each of the plurality of audio signals; outputting first audio signals that have been applied with the head-related transfer functions, among the plurality of audio signals, to an earphone; and outputting the audio signal of one channel corresponding to a location that is in front of a top of a listener's head, among the plurality of audio signals, to a speaker.

According to one embodiment of the present invention, sound image localization in directions in which it is difficult for a listener to localize a sound image can be improved when using earphones.

### BRIEF DESCRIPTION OF DRAWINGS

FIG. 1 is a block diagram showing an example of a main configuration of an audio system;

FIG. 2 is a schematic diagram showing locations of virtual speakers centered on a user when viewed from a vertical direction;

FIG. 3 is a block configuration diagram showing an example of a main configuration of a mobile terminal;

FIG. 4 is a block configuration diagram showing an example of a main configuration of a headphone;

FIG. 5 is a schematic diagram showing an example of a space in which the audio system is used;

FIG. 6 is a schematic diagram showing a region where sound image localization is difficult when the headphone is used;

FIG. 7 is a block configuration diagram showing an example of a main configuration of a speaker;

FIG. 8 is a flowchart showing operation of the mobile terminal in the audio system;

FIG. 9 is a block configuration diagram showing an example of a main configuration of a mobile terminal according to a second embodiment;

FIG. 10 is a flowchart showing operation of the mobile terminal according to the second embodiment;

FIG. 11 is a block configuration diagram showing a main configuration of a headphone according to a third embodiment;

FIG. 12 is a block configuration diagram showing a main configuration of a mobile terminal according to a fourth embodiment;

FIG. 13 is a block configuration diagram showing a main configuration of a mobile terminal according to a first modification;

FIG. 14 is a block configuration diagram showing a main configuration of a mobile terminal according to a second modification;

FIG. 15 is a schematic diagram showing a space in which an audio system according to a third modification is used;

FIG. 16 is an explanatory diagram of an audio system according to a fourth modification, in which a user and speakers are viewed from a vertical direction (in a plan view); and

FIG. 17 is a schematic diagram showing a space in which an audio system according to a fifth modification is used.

### DESCRIPTION OF EMBODIMENTS

### First Embodiment

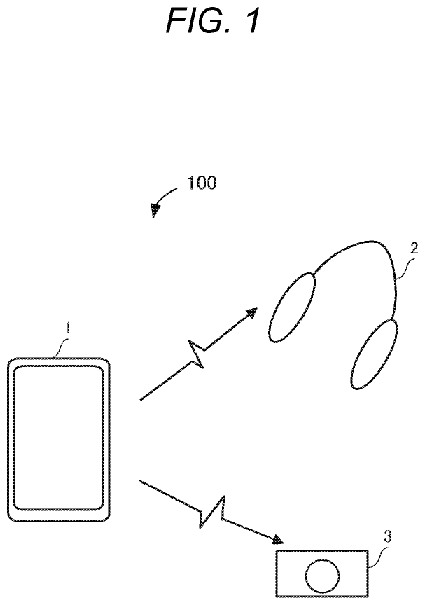

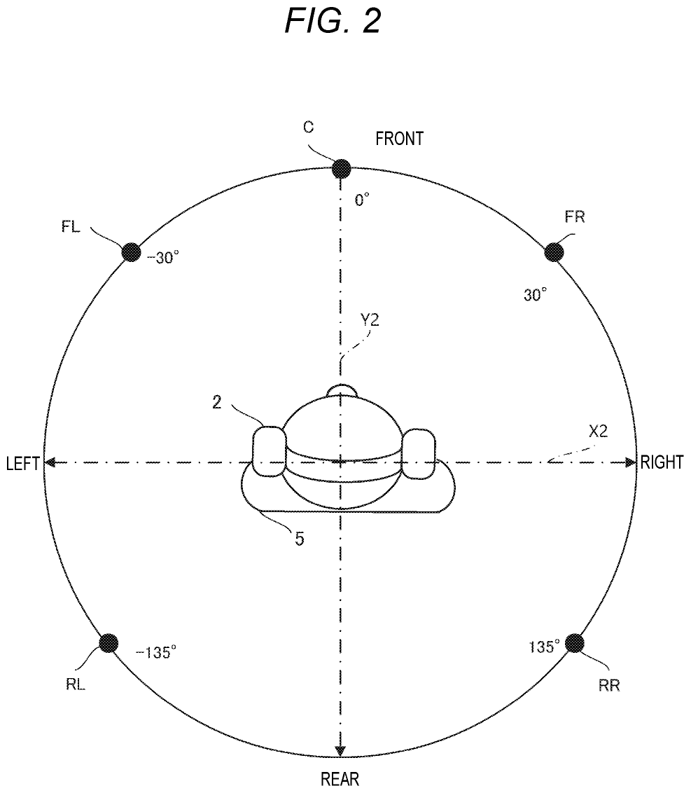

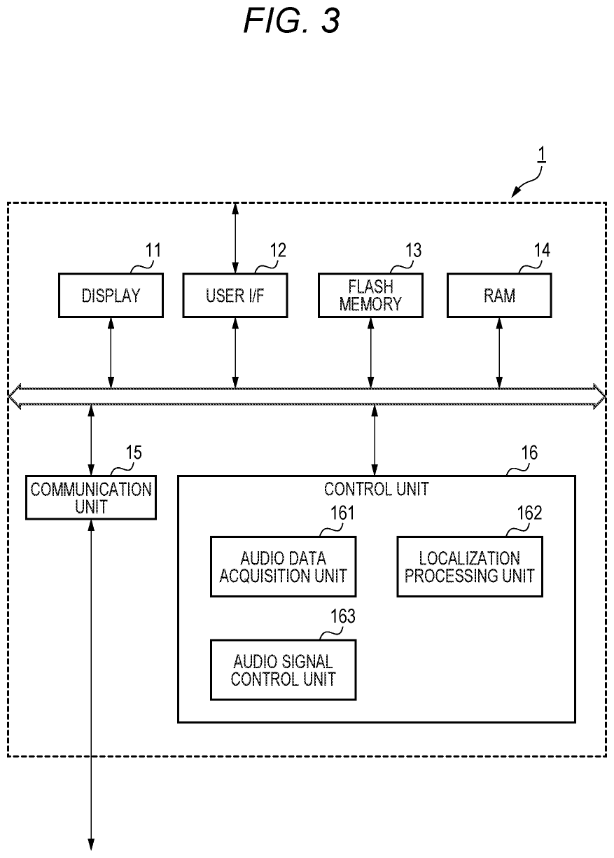

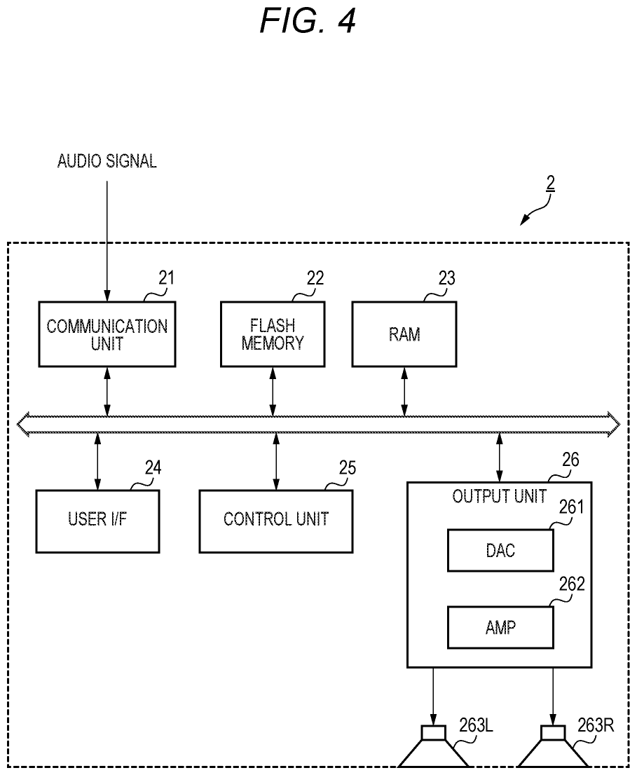

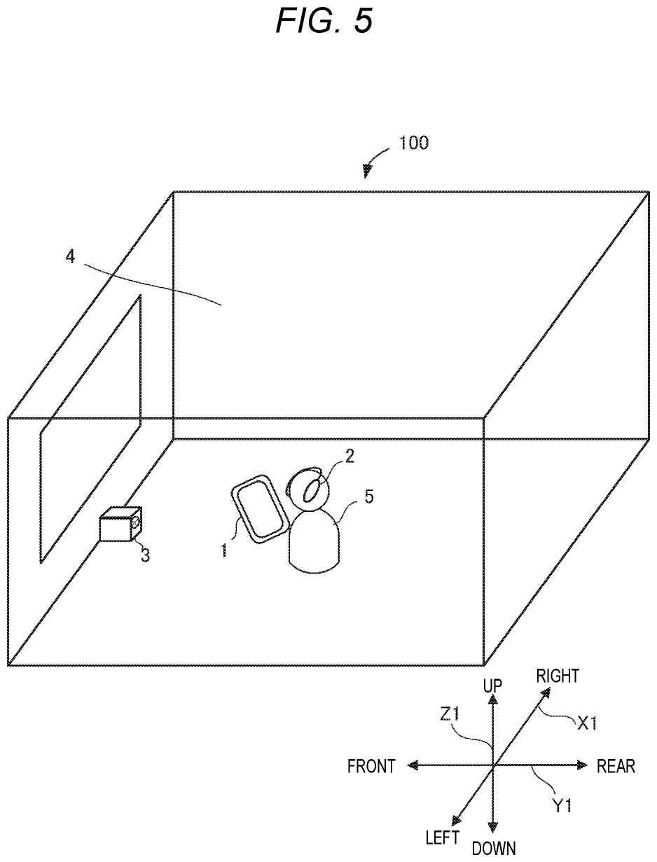

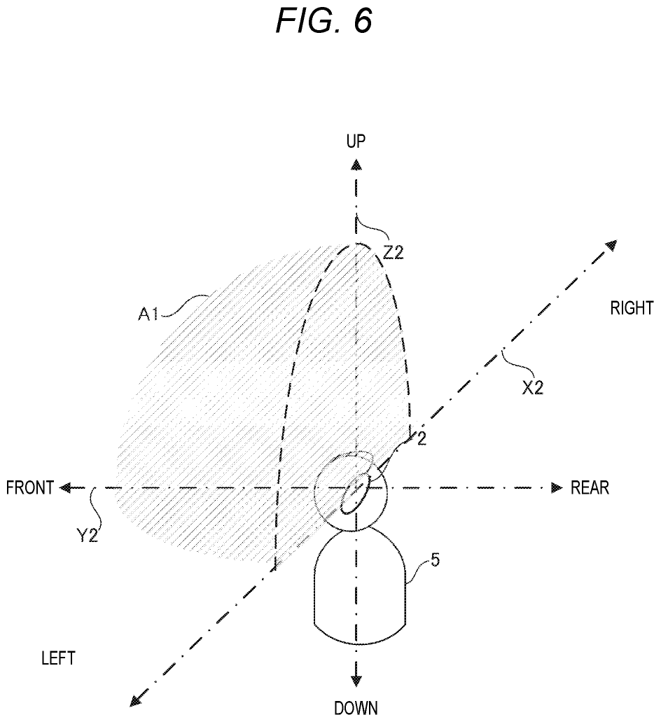

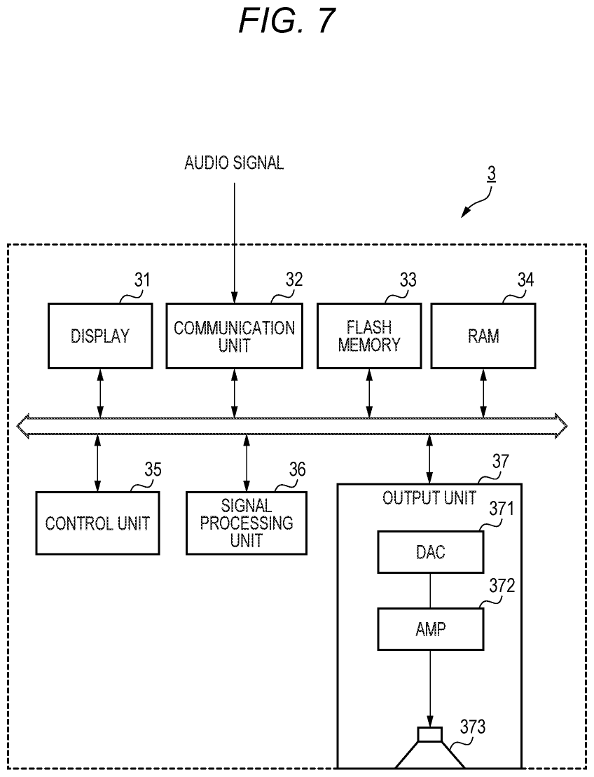

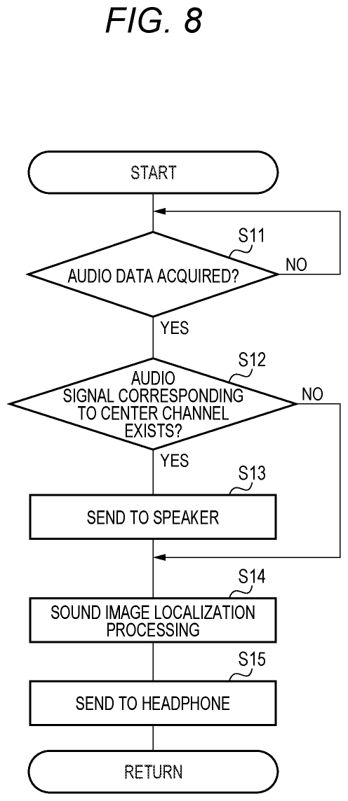

Hereinafter, an audio system 100 according to the first embodiment will be described with reference to the drawings. FIG. 1 is a block diagram showing an example of a configuration of the audio system 100. FIG. 2 is a schematic diagram showing locations of virtual speakers centered on a user 5 when viewed from a vertical direction. In FIG. 2, a direction indicated by an alternate long and short dash line in a left-right direction of a paper surface is defined as a left-right direction X2. In FIG. 2, a direction indicated by an alternate long and short dash line in an up-down direction of the paper surface is defined as a front-rear direction Y2. FIG. 3 is a block configuration diagram showing an example of a configuration of a mobile terminal 1. FIG. 4 is a block configuration diagram showing an example of a main configuration of a headphone 2. FIG. 5 is a schematic diagram showing an example of a space 4 in which the audio system 100 is used. In FIG. 5, a direction indicated by a solid line in the left-right direction of the paper surface is defined as a front-rear direction Y1. In FIG. 5, a direction indicated by a solid line in the up-down direction of the paper surface is defined as a vertical direction Z1. In FIG. 5, a direction indicated by a solid line orthogonal to the front-rear direction Y1 and the vertical direction Z1 is defined as a left-right direction X1. FIG. 6 is a schematic diagram showing a region A1 where sound image localization is difficult when the headphone 2 is used. In FIG. 6, a direction indicated by an alternate long and short dash line in the left-right direction of the paper surface is defined as a front-rear direction Y2. In FIG. 6, a direction indicated by an alternate long and short dash line in the up-down direction of the paper surface is defined as a vertical direction Z2. In FIG. 6, a direction indicated by an alternate long and short dash line orthogonal to the front-rear direction Y2 and the vertical direction Z2 is defined as a left-right direction X2. FIG. 7 is a block configuration diagram showing a main configuration of a speaker 3. FIG. 8 is a flowchart showing operation of the mobile terminal 1 in the audio system 100.

As shown in FIG. 1, the audio system 100 includes the mobile terminal 1, the headphone 2, and the speaker 3. The mobile terminal 1 referred to in this embodiment is an example of an audio signal output device of the present invention. The headphone 2 referred to in this embodiment is an example of an earphone of the present invention. It should be noted that the earphone is not limited to an in-ear type used by being inserted into an ear canal, but also includes an overhead type (headphone) including a headband as shown in FIG. 1.

The audio system 100 plays back a content selected by the user 5. In the present embodiment, the content is, for example, an audio content. The content may include video data. In the present embodiment, audio data includes a plurality of audio signals corresponding to a plurality of channels respectively. In the present embodiment, for example, the audio data includes five audio signals corresponding to five channels (an L channel, an R channel, a center C channel, a rear L channel and a rear R channel) respectively. The user 5 referred to in this embodiment corresponds to a listener in the present invention. The user 5 performs operation related to the audio system 100.

The audio system 100 outputs sound from the headphone 2 based on the audio data included in the content. In the audio system 100, the user 5 wears the headphone 2. The user 5 operates the mobile terminal 1 to instruct selection and playback of the content. For example, when a content playback operation for playing back the content is received from the user 5, the mobile terminal 1 plays back the audio signals included in the audio data. The mobile terminal 1 sends the plurality of played back audio signals to the headphone 2. The headphone 2 emits sound based on the received audio signals.

The mobile terminal 1 performs sound image localization processing on the audio signals corresponding to the plurality of channels respectively. The sound image localization processing is, for example, processing for localizing a sound image as if the sound arrives from a location of a virtual speaker by setting the location of the virtual speaker using a head-related transfer function. The mobile terminal 1 stores the head-related transfer function in advance in a storage unit (for example, a flash memory 13 shown in FIG. 3). The head-related transfer function is a transfer function from the location of the virtual speaker to a head of the user 5 (specifically, a left ear and a right ear of the user 5).

The head-related transfer function will be described in more detail. In the present embodiment, as shown in FIG. 2, the set locations of the virtual speakers are separated from the user 5 by a predetermined distance such as 1 m, and correspond to the five channels (the L channel, the R channel, the center C channel, the rear L channel, and the rear R channel) respectively. Specifically, the virtual speaker corresponding to the L channel is a virtual speaker FL. The virtual speaker corresponding to the R channel is a virtual speaker FR. The virtual speaker corresponding to the center C channel is a virtual speaker C. The virtual speaker corresponding to the rear L channel is a virtual speaker RL. The virtual speaker corresponding to the rear R channel is a virtual speaker RR. The virtual speaker C is located in a front direction (in front) of the user 5. The front direction in which the virtual speaker C is located is 0 degree. A direction of the virtual speaker FR is 30 degrees, a direction of the virtual speaker RR is 135 degrees, a direction of the virtual speaker RL is −135 degrees, and a direction of the virtual speaker FL is −30 degrees.

The head-related transfer functions from the respective locations of the virtual speaker FL, the virtual speaker FR, the virtual speaker C, the virtual speaker RL, and the virtual speaker RR to the head of the user 5 include two kinds of head-related transfer functions, in which one is from the respective locations of the virtual speaker FL, the virtual speaker FR, the virtual speaker C, the virtual speaker RL, and the virtual speaker RR to the right ear and the other is to the left ear. The mobile terminal 1 reads the head-related transfer functions corresponding to the virtual speaker FL, the virtual speaker FR, the virtual speaker C, the virtual speaker RL, and the virtual speaker RR, and separately convolutes the head-related transfer function to the right ear and the head-related transfer function to the left ear into the audio signal of each channel. The mobile terminal 1 sends an audio signal of each channel in which the head-related transfer function to the right ear is convoluted to the headphone 2, as an audio signal corresponding to the R (right) channel. The mobile terminal 1 sends an audio signal of each channel in which the head-related transfer function to the left ear is convoluted to the headphone 2, as an audio signal corresponding to the L (left) channel.

The headphone 2 emits sound based on the received audio signals.

Hereinafter, the configuration of the mobile terminal 1 will be described with reference to FIG. 3. As shown in FIG. 3, the mobile terminal 1 includes a display 11, a user interface (I/F) 12, a flash memory 13, a RAM 14, a communication unit 15, and a control unit 16.

The display 11 displays various kinds of information according to control by the control unit 16. The display 11 includes, for example, an LCD. The display 11 stacks touch panels, which is one aspect of the user I/F 12, and displays a graphical user interface (GUI) screen for receiving the operation by the user 5. The display 11 displays, for example, a speaker setting screen, a content playback screen, and a content selection screen.

The user I/F 12 receives operation on the touch panel by the user 5. The user I/F 12 receives, for example, content selection operation for selecting a content from the content selection screen displayed on the display 11. The user I/F 12 receives, for example, content playback operation from the content playback screen displayed on the display 11.

The communication unit 15 includes, for example, a wireless communication I/F conforming to a standard such as Wi-Fi (registered trademark) and Bluetooth (registered trademark). The communication unit 15 includes a wired communication I/F conforming to a standard such as USB. The communication unit 15 sends an audio signal corresponding to a stereo channel to the headphone 2 by, for example, wireless communication. The communication unit 15 sends the audio signals to the speaker 3 by wireless communication.

The flash memory 13 stores a program related to operation of the mobile terminal 1 in the audio system 100. The flash memory 13 also stores the head-related transfer functions. The flash memory 13 further stores the content.

The control unit 16 reads the program stored in the flash memory 13, which is a storage medium, into the RAM 14 to implement various functions. The various functions include, for example, audio data acquisition processing, localization processing, and audio signal control processing. More specifically, the control unit 16 reads programs related to the audio data acquisition processing, the localization processing, and the audio signal control processing into the RAM 14. As a result, the control unit 16 includes an audio data acquisition unit 161, a localization processing unit 162, and an audio signal control unit 163.

The control unit 16 may download the programs for executing the audio data acquisition processing, the localization processing, and the audio signal control processing from, for example, a server. Therefore, the control unit 16 may include the audio data acquisition unit 161, the localization processing unit 162, and the audio signal control unit 163.

For example, when the content selection operation by the user 5 is received from the user I/F 12, the audio data acquisition unit 161 acquires the audio data included in the content. The audio data includes the audio signals corresponding to the L channel, the R channel, the center C channel, the rear L channel, and the rear R channel respectively.

The localization processing unit 162 gives the head-related transfer function for localizing a sound image to a location determined for each channel to each of the plurality of audio signals corresponding to the plurality of channels respectively. As shown in FIG. 2, the localization processing unit 162 localizes a sound image of the virtual speaker FL of the L channel to a front left side (−30 degrees) of the user 5, a sound image of the virtual speaker C of the center C channel to a front side (0 degree) of the user 5, a sound image of the virtual speaker FR of the R channel to a front right side (30 degrees) of the user 5, a sound image of the virtual speaker RL of the rear L channel to a rear left side (−135 degrees) of the user 5, and a sound image of the virtual speaker RR of the rear R channel to a rear right side (135 degrees) of the user 5, using the head-related transfer functions. The localization processing unit 162 reads from the flash memory 13 the head-related transfer functions corresponding to the virtual speakers (the virtual speaker FL, the virtual speaker FR, the virtual speaker C, the virtual speaker RL, and the virtual speaker RR). The localization processing unit 162 convolutes the head-related transfer function corresponding to each virtual speaker to the audio signal of each channel.

That is, the localization processing unit 162 convolutes the head-related transfer function corresponding to the virtual speaker FL to the audio signal corresponding to the L channel. The localization processing unit 162 convolutes the head-related transfer function corresponding to the virtual speaker FR to the audio signal corresponding to the R channel. The localization processing unit 162 convolutes the head-related transfer function corresponding to the virtual speaker C to the audio signal corresponding to the center C channel. The localization processing unit 162 convolutes the head-related transfer function corresponding to the virtual speaker RL to the audio signal corresponding to the rear L channel. The localization processing unit 162 convolutes the head-related transfer function corresponding to the virtual speaker RR to the audio signal corresponding to the rear R channel. The localization processing unit 162 generates an audio signal corresponding to a stereo L channel in which the head-related transfer functions from the locations of the virtual speakers FL, FR, C, RL, and RR to the left ear are convoluted, and an audio signal corresponding to a stereo R channel in which the head-related transfer functions from the locations of the virtual speakers FL, FR, C, RL, and RR to the right ear are convoluted.

The audio signal control unit 163 outputs a stereo signal including the audio signal corresponding to the stereo L channel and the audio signal corresponding to the stereo R channel after the sound image localization processing by the localization processing unit 162, to the headphone 2 via the communication unit 15.

The audio signal control unit 163 extracts an audio signal corresponding to a channel corresponding to a location that is in front of a top of the head of the user 5, among the plurality of audio signals included in the audio data. The audio signal control unit 163 sends the extracted audio signal to the speaker 3 via the communication unit 15. The channel corresponding to the location that is in front of a top of the head of the user 5 will be described later.

The headphone 2 will be described with reference to FIG. 4. As shown in FIG. 4, the headphone 2 includes a communication unit 21, a flash memory 22, a RAM 23, a user interface (I/F) 24, a control unit 25, and an output unit 26.

The user I/F 24 receives operation from the user 5. The user I/F 24 receives, for example, content playback on/off switching operation or volume level adjustment operation.

The communication unit 21 receives an audio signal from the mobile terminal 1. The communication unit 21 sends a signal based on the user operation received by the user I/F 24 to the mobile terminal 1.

The control unit 25 reads an operation program stored in the flash memory 22 into the RAM 23 and executes various functions.

The output unit 26 is connected to a speaker unit 263L and a speaker unit 263R. The output unit 26 outputs an audio signal after signal processing to the speaker unit 263L and the speaker unit 263R. The output unit 26 includes a DA converter (hereinafter referred to as DAC) 261 and an amplifier (hereinafter referred to as AMP) 262. The DAC 261 converts a digital signal after the signal processing into an analog signal. The AMP 262 amplifies the analog signal for driving the speaker unit 263L and the speaker unit 263R. The output unit 26 outputs the amplified analog signal (audio signal) to the speaker unit 263L and the speaker unit 263R.

The audio system 100 according to the first embodiment is used, for example, in the space 4, as shown in FIG. 5. The space 4 is, for example, a living room. The user 5 listens to the content via the headphone 2 near a center of the space 4.

In use of the headphone 2, it may be difficult to localize the sound image when the sound image is localized using the head-related transfer function. For example, in the use of the headphone, when the location of the virtual speaker is included in the region A1 that is in front of the top of the head of the user 5 as shown in FIG. 6, it becomes difficult to localize the sound image. Particularly, the user 5 may not be able to obtain a “forward localization” or a “sense of distance” with the virtual speaker when the location of the virtual speaker exists in the region A1. The sound image localization also affects vision. Since the sound image localization using the head-related transfer function is virtual localization, the mobile terminal 1 cannot actually see the virtual speaker in the region A1 of the user 5. Therefore, even when the location of the virtual speaker exists in the region A1, the user 5 may not be able to perceive the sound image of the virtual speaker existing in the region A1 and may perceive the virtual speaker at a location of the headphone 2 (the head).

In this regard, the audio system 100 according to the present embodiment causes the speaker in front of the user 5 to emit sound. For example, as shown in FIG. 5, the user 5 listens to the content facing a front side of a room (a front side in the front-rear direction Y1). The speaker 3 is arranged in the front side of the space 4 (the front side in the front-rear direction Y1) and in a center of the left-right direction X1. In other words, the speaker 3 is arranged in front of the user 5. In this embodiment, the mobile terminal 1 sets a channel corresponding to the location that is in front of the top of the head of the user 5 as the center C channel. The mobile terminal 1 determines the speaker 3 in front of the user 5 as a speaker for emitting sound related to the center C channel. The mobile terminal 1 sends an audio signal corresponding to the center C channel to the speaker 3.

The speaker 3 actually emits the sound related to the center C channel from a distant location in front of the user 5. As a result, the user 5 can perceive the sound image of the center C channel at the distant location in front of the user 5. Therefore, the audio system 100 of the present embodiment can improve the sense of localization by compensating for the “forward localization” and the “sense of distance” that cannot be obtained by the head-related transfer function with the speaker 3.

The speaker 3 will be described with reference to FIG. 7. As shown in FIG. 7, the speaker 3 includes a display 31, a communication unit 32, a flash memory 33, a RAM 34, a control unit 35, a signal processing unit 36, and an output unit 37.

The display 31 includes a plurality of LEDs or LCDs. The display 31 displays, for example, a state of connection to the mobile terminal 1. The display 31 may also display, for example, content information during playback. In this case, the speaker 3 receives the content information included in the content from the mobile terminal 1.

The communication unit 32 includes, for example, a wireless communication I/F conforming to a standard such as Wi-Fi (registered trademark) and Bluetooth (registered trademark). The communication unit 32 receives an audio signal corresponding to the center C channel from the mobile terminal 1 by wireless communication.

The control unit 35 reads a program stored in the flash memory 33, which is a storage medium, into the RAM 34 to implement various functions. The control unit 35 inputs the audio signal received via the communication unit 32 to the signal processing unit 36.

The signal processing unit 36 includes one or a plurality of DSPs. The signal processing unit 36 performs various kinds of signal processing on the input audio signal. The signal processing unit 36 applies, for example, signal processing such equalizer processing to the audio signal.

The output unit 37 includes a DA converter (DAC) 371, an amplifier (AMP) 372, and a speaker unit 373. The DA converter 371 converts the audio signal processed by the signal processing unit 36 into an analog signal. The amplifier 372 amplifies the analog signal. The speaker unit 373 emits the amplified analog signal. The speaker unit 373 may be a separate body.

The operation of the mobile terminal 1 in the audio system 100 will be described with reference to FIG. 8.

If the audio data is acquired (S11: Yes), the mobile terminal 1 determines whether there is an audio signal corresponding to the center C channel among the audio signals included in the audio data (S12). If there is an audio signal corresponding to the center C channel (S12: Yes), the mobile terminal 1 sends the audio signal corresponding to the center C channel to the speaker 3 (S13). The mobile terminal 1 performs the sound image localization processing on the audio signal corresponding to each channel using the head-related transfer function (S14). The mobile terminal 1 sends the audio signal after the sound image localization processing to the headphone 2 (S15).

The speaker 3 receives the audio signal sent from the mobile terminal 1. The speaker 3 emits sound based on the received audio signal.

If there is no audio signal corresponding to the center C channel (S12: No), the mobile terminal 1 shifts the processing to the sound image localization processing (S14).

The headphone 2 receives the audio signal sent from the mobile terminal 1. The headphone 2 emits the sound based on the received audio signal.

When the user 5 uses the headphone 2, the mobile terminal 1 may have difficulty localizing the sound image of the virtual speaker. In this case, the audio signal corresponding to the center C channel is sent to a speaker located in front of the user 5 (the speaker 3 in this embodiment) in order to compensate for the sense of localization. As a result, even when it is difficult to localize the sound image with the headphone 2 alone, the speaker 3 can compensate for the sense of localization by emitting sound based on the audio signal corresponding to the center C channel. The mobile terminal 1 can improve the sound image localization in a direction in which it is difficult for the user 5 to localize the sound image when the headphone 2 is used.

In the above embodiment, an example in which the audio signal corresponding to the center C channel is sent to the speaker 3 is described, but the L channel and the R channel are also examples of the channel corresponding to the location in front of the top of the head of the listener. For example, the mobile terminal 1 may send an audio signal corresponding to the L channel or the R channel to the speaker 3. When speakers are installed on a front left side and a front right side of the user 5, the mobile terminal 1 sends an audio signal of the L channel audio signal to the front left side speaker and an audio signal of the R channel to the front right side speaker.

### Second Embodiment

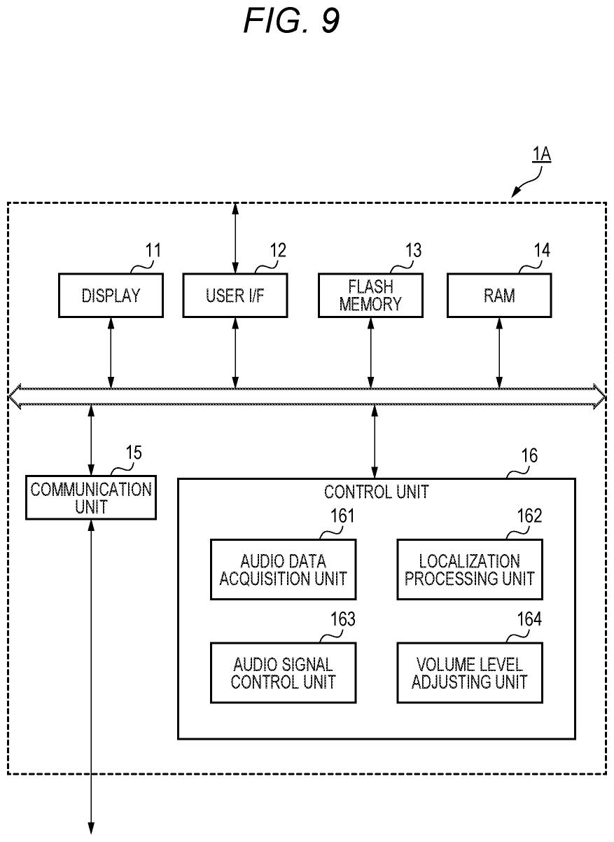

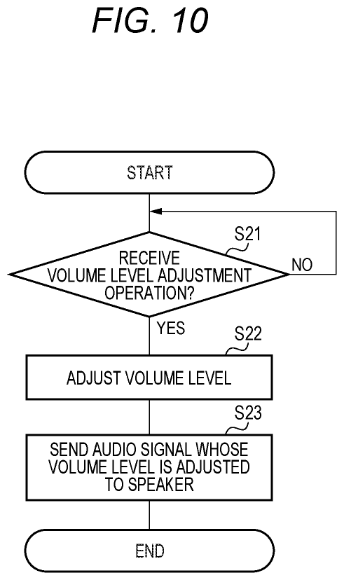

The audio system 100 according to the second embodiment adjusts a volume level of the sound emitted by the speaker 3 by a mobile terminal 1A. The second embodiment will be described with reference to FIGS. 9 and 10. FIG. 9 is a block configuration diagram showing an example of a main configuration of the mobile terminal 1A according to the second embodiment. FIG. 10 is a flowchart showing operation of the mobile terminal 1A according to the second embodiment. The same components as those in the first embodiment are designated by the same reference numerals, and detailed description thereof will be omitted.

The mobile terminal 1A controls the volume level of the sound emitted from the speaker 3. As shown in FIG. 9, the mobile terminal 1A further includes a volume level adjusting unit 164. The volume level adjusting unit 164 adjusts the volume level of the sound emitted from the speaker 3 that receives the audio signal corresponding to the center C channel, which is the channel corresponding to the location in front of the top of the head. The volume level adjusting unit 164 adjusts the volume level of the audio signal to be sent to the speaker 3 and sends the audio signal whose volume level is adjusted to the speaker 3 via the communication unit 15.

For example, in the example of the first embodiment, the sound related to the center C channel is emitted from the speaker 3. In this case, since the sound related to the center C channel is emitted from both the headphone 2 and the speaker 3, the volume level of the sound related to the center C channel may be relatively higher than volume levels of sound related to channels other than the center C channel.

Therefore, the mobile terminal 1A adjusts the volume level of the audio signal sent to the speaker 3 based on the operation from the user 5. In this case, the user 5 adjusts the volume level of the audio signal sent to the speaker 3 based on the operation received via the user I/F 12 of the mobile terminal 1A before or during the playback of the content. Then, the mobile terminal 1A sends an audio signal whose volume level is adjusted to the speaker 3. The speaker 3 receives the audio signal whose volume level is adjusted.

An example of the operation of adjusting the volume level by the mobile terminal 1A will be described with reference to FIG. 10. If the mobile terminal 1A receives volume level adjustment operation via the user I/F 12 (S21: Yes), the mobile terminal 1A adjusts the volume level of the audio signal to be sent to the speaker 3 based on the volume level adjustment operation (S22). The mobile terminal 1A sends the audio signal whose volume level is adjusted to the speaker 3 (S23).

In this way, the mobile terminal 1A according to the second embodiment adjusts the volume level of the sound emitted from the speaker 3 based on the operation from the user 5. As a result, when the user 5 feels that the sound related to the center C channel is too loud than the sound related to the channels other than the center C channel, the user 5 can listen to the content without discomfort by lowering the volume level of the sound of the speaker 3. When the user 5 feels that the sense of localization is weak in the use of the headphone 2, the sound image localization can be improved by raising the volume level of the sound of the speaker 3.

The volume level adjusting unit 164 may generate volume level information indicating the volume level, and may send the volume level information to the speaker 3 via the communication unit 15. More specifically, the volume level adjusting unit 164 sends the volume level information for adjusting the volume of the sound emitted from the speaker 3 to the speaker 3 according to the received volume level adjustment operation. The speaker 3 adjusts the volume level of the sound to be emitted based on the received volume level information.

### Third Embodiment

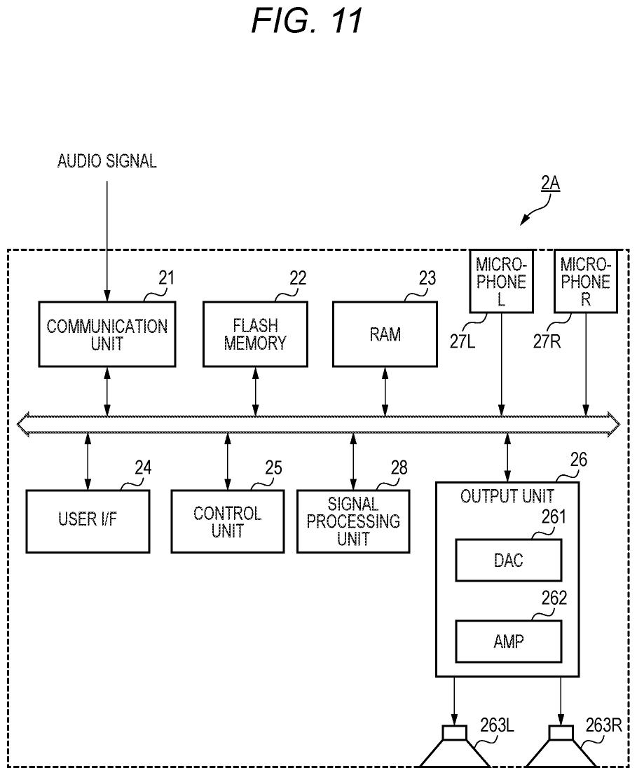

The audio system 100 according to the third embodiment acquires the external sound through a microphone installed in a headphone 2A. The headphone 2A outputs the acquired external sound from the speaker unit 263L and the speaker unit 263R. The third embodiment will be described with reference to FIG. 11. FIG. 11 is a block configuration diagram showing a main configuration of the headphone 2A in the third embodiment. The same components as those in the first embodiment are designated by the same reference numerals, and detailed description thereof will be omitted.

As shown in FIG. 11, the headphone 2A includes a microphone 27L and a microphone 27R.

The microphone 27L and the microphone 27R collect the external sound. The microphone 27L is provided in, for example, a head unit attached to the left ear of the user 5. The microphone 27R is provided in, for example, a head unit attached to the right ear of the user 5.

In the headphone 2A, for example, when the sound is emitted from the speaker 3, the microphone 27L and the microphone 27R are turned on. That is, in the headphone 2A, for example, when the sound is emitted from the speaker 3, the microphone 27L and the microphone 27R collect the external sound.

The headphone 2A filters a sound signal collected by the microphone 27L and the microphone 27R by the signal processing unit 28. The headphone 2A does not emit the collected sound signal as it is from the speaker unit 263L and the speaker unit 263R, but filters the sound signal by a filter coefficient for correcting a difference in sound quality between the collected sound signal and the actual external sound. More specifically, the headphone 2A digitally converts the collected sound and performs signal processing. The headphone 2A converts the sound signal after the signal processing into an analog signal and emits sound from the speaker unit 263L and the speaker unit 263R.

In this way, the headphone 2A adjusts the sound signal after the signal processing so that the user 5 acquires the same sound quality as when he or she directly listens to the external sound. As a result, the user 5 can listen to the external sound as if he or she is directly listening to the external sound without going through the headphone 2A.

In the audio system 100 according to the third embodiment, the mobile terminal 1 sends to the speaker 3 the audio signal corresponding to the center C channel, which is the channel corresponding to the location that is in front of the top of the head of the user 5. The speaker 3 emits sound based on the audio signal. The headphone 2A collects the sound emitted by the speaker 3 by the microphone 27L and the microphone 27R. The headphone 2A performs the signal processing on the audio signal based on the collected sound, and emits the sound from the speaker units 263L and 263R. The user 5 can listen to the external sound as if he or she does not wear the headphone 2A. As a result, the user 5 can perceive the sound emitted from the speaker 3 and more strongly recognize the sense of distance from the virtual speaker. Therefore, the audio system 100 can further improve the sound image localization.

The headphone 2A according to the third embodiment may stop the audio signal corresponding to the center C channel (adjust the volume level to 0 level) at a timing when the external sound is collected. In this case, the headphone 2A emits only the sound related to the channels other than the center C channel.

When the microphone 27L and the microphone 27R do not collect the sound from the speaker 3, the microphone 27L and the microphone 27R may be in an off state.

The microphone 27L and the microphone 27R may be set to an ON state so as to collect the external sound even when no sound is emitted from the speaker 3. In this case, the headphone 2A can reduce noise from outside by using a noise canceling function. The noise canceling function is to generate a sound having a phase opposite to the collected sound (noise) and emit the sound having the opposite phase together with the sound based on the audio signal. The headphone 2A turns off the noise canceling function when the noise canceling function is in an on state and the sound is emitted from the speaker 3. More specifically, the headphone 2A determines whether the sound collected by the microphone 27L and the microphone 27R is the sound emitted from the speaker 3. When the collected sound is the sound emitted from the speaker 3, the headphone 2A turns off the noise canceling function, performs signal processing on the collected sound, and emits the sound.

### Fourth Embodiment

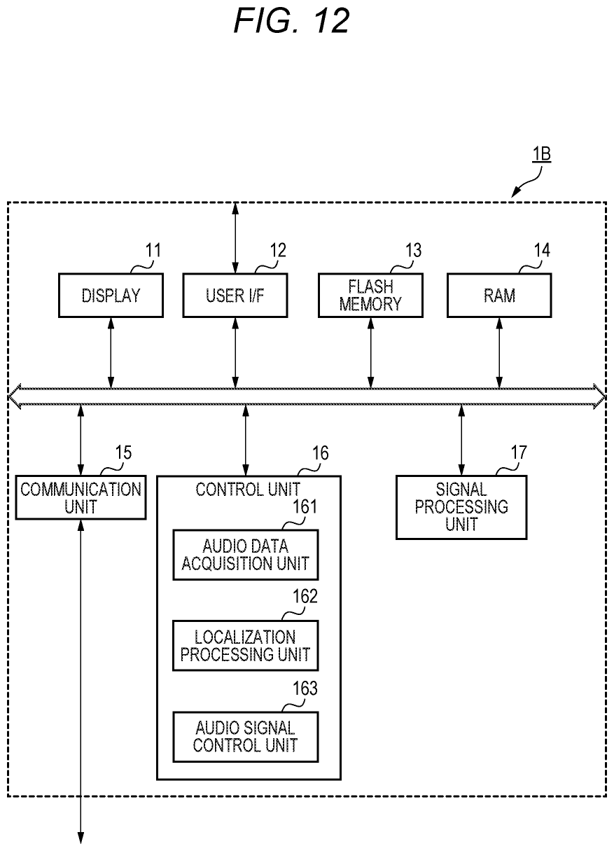

In the audio system 100 according to the fourth embodiment, an output timing of the audio signal output to the headphone 2 is adjusted based on speaker location information. A mobile terminal 1B according to the fourth embodiment will be described with reference to FIG. 12. FIG. 12 is a block configuration diagram showing a main configuration of the mobile terminal 1B according to the fourth embodiment. The same components as those in the first embodiment are designated by the same reference numerals, and detailed description thereof will be omitted.

A timing at which the sound is emitted from the speaker 3 and a timing at which the sound is emitted from the headphone 2 may be different. Specifically, the headphone 2 is worn on the ears of the user 5, and the sound is emitted directly to the ears. On the other hand, there is a space between the speaker 3 and the user 5, and the sound emitted from the speaker 3 reaches the ears of the user 5 through the space 4. In this way, the sound emitted from the speaker 3 reaches the ears of the user 5 with a delay compared with the sound emitted from the headphone 2. The mobile terminal 1B delays, for example, the timing at which the sound is emitted from the headphone 2 in order to match the timing at which the sound is emitted from the speaker 3 with the timing at which the sound is emitted from the headphone 2.

The mobile terminal 1B includes a signal processing unit 17 as shown in FIG. 12. The signal processing unit 17 includes one or a plurality of DSPs. In this embodiment, the mobile terminal 1B stores a listening position and an arrangement location of the speaker 3. The mobile terminal 1B displays, for example, a screen that imitates the space 4. The mobile terminal 1B calculates a delay time between the listening position and the speaker 3. For example, the mobile terminal 1B sends an instruction signal to the speaker 3 so as to emit test sound from the speaker 3. By receiving the test sound from the speaker 3, the mobile terminal 1B calculates a delay time of the speaker 3 based on a difference between a time when the instruction signal is sent and a time when the test sound is received. The signal processing unit 17 performs delay processing on the audio signal to be sent to the headphone 2 according to the delay time between the listening position and the speaker 3.

The mobile terminal 1B according to the fourth embodiment adjusts arrival timings of the sound emitted from the speaker 3 and the sound emitted from the headphone 2 by performing the delay processing on the audio signal sent to the headphone 2. As a result, the user 5 listens to the sound emitted from the speaker 3 and the sound emitted from the headphone 2 at the same timing, so that there is no deviation of the same sound and deterioration of the sound quality can be reduced. Therefore, even when the sound related to the center C channel is emitted from the speaker 3, the content can be listened to without discomfort.

### First Modification

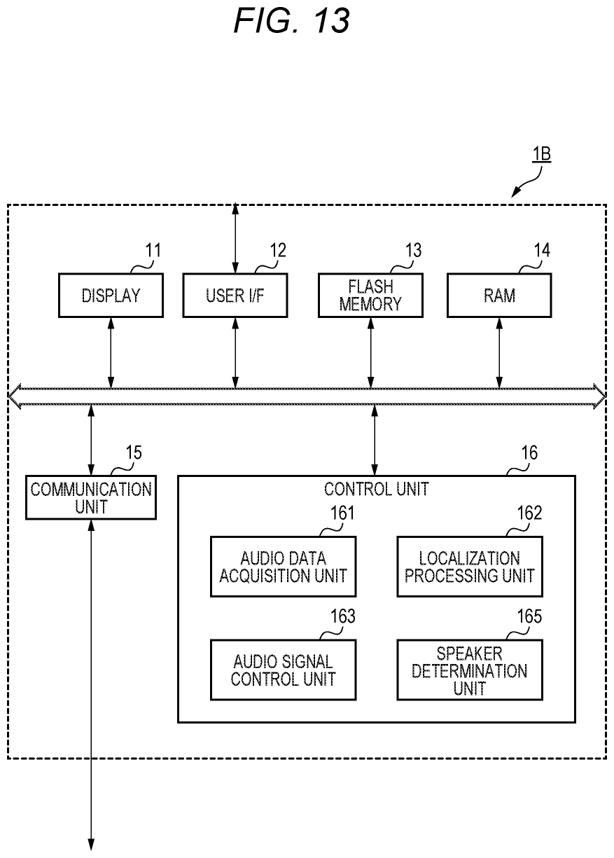

A mobile terminal 1C according to the first modification receives operation of determining a center speaker corresponding to the center C channel via the user I/F 12. The mobile terminal 1C determines the center speaker that emits the sound related to the center C channel based on the operation. The mobile terminal 1C according to the first modification will be described with reference to FIG. 13. FIG. 13 is a block configuration diagram showing a main configuration of the mobile terminal 1C according to the first modification. The same components as those in the first embodiment are designated by the same reference numerals, and detailed description thereof will be omitted.

The mobile terminal 1C includes a speaker determination unit 165. The mobile terminal 1C stores a location (for example, coordinates) of each speaker in advance. The speaker determination unit 165 determines the center speaker based on operation from the user 5. The speaker determination unit 165 displays, the screen that imitates the space 4 on the display 11 for example. In this case, the screen displays a speaker connected to the mobile terminal 1C and the location of the speaker. For example, when the user 5 selects a speaker, the speaker determination unit 165 changes the speaker that emits the sound related to the center C channel. It should be noted that the speaker connected to the mobile terminal 1C includes speakers attached to a PC and a mobile phone.

As a result, the user 5 can use the mobile terminal 1 to freely select the speaker from which the sound related to the center C channel is to be emitted.

It should be note that the mobile terminal 1 may display a list of all speakers connected to the mobile terminal 1.

### Second Modification

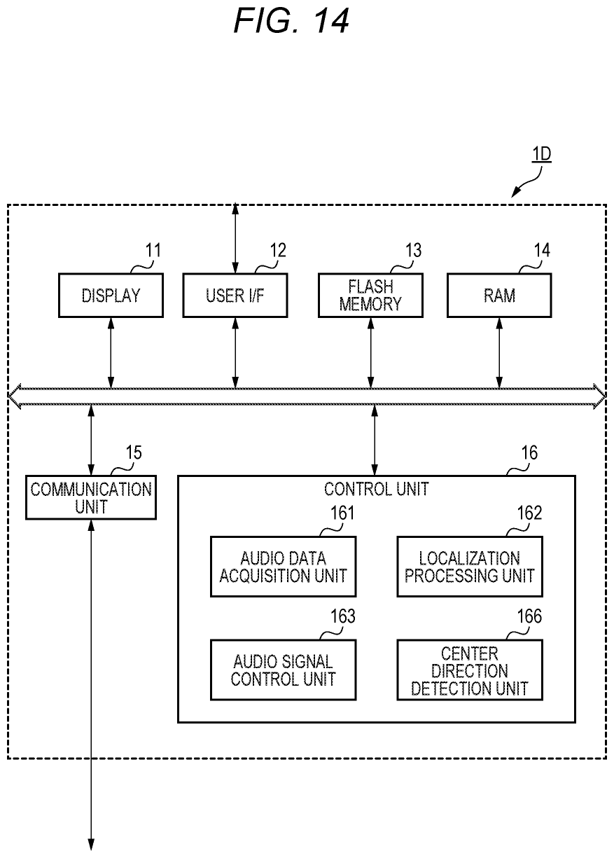

A mobile terminal 1D according to the second modification detects a center direction, which is a direction the user 5 faces, and determines a speaker to which the audio signal is sent based on the detected center direction. The mobile terminal 1D according to the second modification will be described with reference to FIG. 14. FIG. 14 is a block configuration diagram showing a main configuration of the mobile terminal according to the second modification. As shown in FIG. 14, the mobile terminal 1D further includes a center direction detection unit 166. The center direction detection unit 166 receives center direction information related to the center direction of the user 5 from the headphone 2, and based on the received center direction information, determines the speaker to which the audio signal corresponding to the center C channel is sent.

The mobile terminal 1D detects the center direction of the user 5 using a head tracking function. The head tracking function is a function of the headphone 2. The headphone 2 tracks movement of the head of the user 5 who wears the headphone 2.

The center direction detection unit 166 determines a reference direction based on operation from the user 5. The center direction detection unit 166 receives and stores a direction of the speaker 3 by, for example, operation from the user 5. For example, the center direction detection unit 166 displays an icon described as “center reset” on the display 11 and receives operation from the user 5. The user 5 taps the icon when facing the speaker 3. The center direction detection unit 166 assumes that the speaker 3 is installed in the center direction at the time of tapping, and stores the direction (reference direction) of the speaker 3. In this case, the mobile terminal 1D determines the speaker 3 as the speaker corresponding to the center C channel. The mobile terminal 1D may be assumed as receiving the operation of the “center reset” during start-up, or may be assumed as receiving the operation of the “center reset” when a program shown in the present embodiment is started.

The headphone 2 includes a plurality of sensors such as an acceleration sensor and a gyro sensor. The headphone 2 detects a direction of the head of the user 5 by using, for example, an acceleration sensor or a gyro sensor. The headphone 2 calculates an amount of change in movement of the head of the user 5 from an output value of the acceleration sensor or the gyro sensor. The headphone 2 sends the calculated data to the mobile terminal 1D. The center direction detection unit 166 calculates a changed angle of the head with reference to the above-mentioned reference direction. The center direction detection unit 166 detects the center direction based on the calculated angle. The center direction detection unit 166 may calculate the angle by which the direction of the head changes at regular intervals, and may set the direction the user faces at the time of calculation as the center direction.

The mobile terminal 1D sends an audio signal to the speaker corresponding to the center C channel (the speaker 3 in this embodiment). When the direction of the head of the user 5 changes to a right side by 30 degrees in a plan view, the speaker 3 exists in a direction in a left side of the user 5 by 30 degrees. In this case, the mobile terminal 1D may send an audio signal corresponding to the L channel to the speaker 3. When the direction of the head of the user 5 changes to a left side by 30 degrees in the plan view, the speaker 3 exists in a direction in a right side of the user 5 by 30 degrees. In this case, the mobile terminal 1D may send an audio signal corresponding to the R channel to the speaker 3.

For example, when the user 5 turns 90 degrees to the right side after the user 5 presses the “center reset” toward the speaker 3, the mobile terminal 1D sets the center direction to 90 degrees to the right side. That is, the speaker 3 is located on a left side of the user 5. In this case, the mobile terminal 1D may stop sending the audio signal to the speaker 3 when the direction of the head of the user 5 changes by 90 degrees or more in the plan view.

In this way, by using the tracking function of the headphone 2, the mobile terminal 1D can cause a speaker to emit the sound related to the center channel only when the speaker exists in the center direction of the user 5. Therefore, the mobile terminal 1D can appropriately cause the speaker to emit sound according to the direction of the head of the user 5 to improve the sound image localization.

### Third Modification

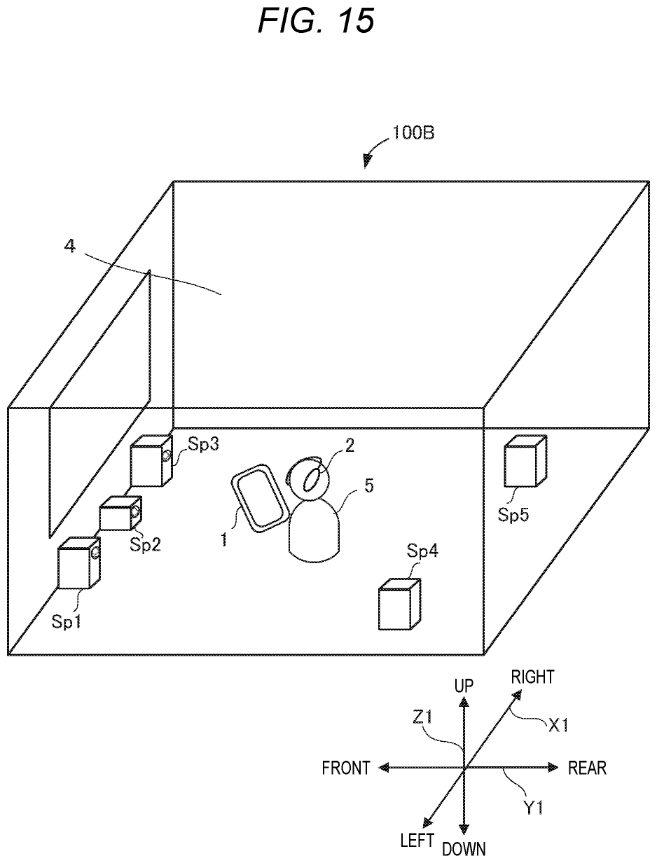

A method for detecting a relative location of the mobile terminal 1 and the speaker according to the third modification will be described with reference to FIG. 15. FIG. 15 is a schematic diagram showing an example of the space 4 in which an audio system 100B according to the third modification is used. The audio system 100B according to the third modification includes, for example, a plurality of (five) speakers. That is, as shown in FIG. 15, a speaker Sp1, a speaker Sp2, a speaker Sp3, a speaker Sp4, and a speaker Sp5 are arranged in the space 4.

The user 5 detects locations of the speakers using, for example, a microphone of the mobile terminal 1. More specifically, the microphone of the mobile terminal 1 collects test sound emitted from the speaker Sp1 at three places close to the listening position, for example. The mobile terminal 1 calculates a relative location between a location P1 of the speaker Sp1 and the listening position based on the test sound collected at the three places. The mobile terminal 1 calculates a time difference between a timing at which the test sound is emitted and a timing at which the test sound is collected for each of the three locations. The mobile terminal 1 obtains a distance between the speaker Sp1 and the microphone based on the calculated time difference. The mobile terminal 1 obtains the distance to the microphone from each of the three locations, and calculates the relative location between the location 1 of the speaker Sp1 and the listening position by a principle of trigonometric function (trigonometric survey). In this way, relative locations between each of the speaker Sp2 to the speaker Sp5 and the listening position are sequentially calculated by the same method.

The user 5 may provide three microphones to collect the test sound at the three places at the same time. One of the three locations close to the listening position may be the listening position.

The mobile terminal 1 stores the relative locations between each of the speaker Sp1, the speaker Sp2, the speaker Sp3, the speaker Sp4, and the speaker Sp5 and the listening position in a storage unit.

As described above, in the audio system 100B according to the third modification, the locations of the speaker Sp1, the speaker Sp2, the speaker Sp3, the speaker Sp4, and the speaker Sp5 can be automatically detected.

The listening position may be set by operation from the user. In this case, for example, the mobile terminal 1 displays a schematic screen showing the space 4 and receives the operation from the user.

The mobile terminal 1 automatically assigns a channel corresponding to each speaker based on the detected locations of the speaker Sp1, the speaker Sp2, the speaker Sp3, the speaker Sp4, and the speaker Sp5. In this case, for example, if the center direction is set to the front side in the front-rear direction Y1 and the center in the left-right direction X1 of the space 4, the mobile terminal 1 assigns a channel to each detected speaker as follows. The mobile terminal 1 assigns, for example, the L channel to the speaker Sp1, the center C channel to the speaker Sp2, the R channel to the speaker Sp3, the rear L channel to the speaker Sp4, and the rear R channel to the speaker Sp5.

When the center direction of the user 5 faces between the plurality of speakers, the mobile terminal 1C may perform panning processing of distributing the sound signal of the center C channel with a predetermined gain ratio on the audio signals respectively corresponding to the two speakers installed with the center direction of the user 5 sandwiched therebetween, and may set a virtual speaker that is phantom-localized in the center direction of the user 5. For example, when the center direction of the user 5 faces between the speaker Sp4 and the speaker Sp5, the mobile terminal 1 performs the panning processing of distributing the audio signal corresponding to the center C channel with a predetermined gain ratio on the speaker Sp4 and the speaker Sp5. Similarly, the panning processing may be performed on the audio signal of the L channel or the audio signal of the R channel. As a result, even when there is no real speaker in the direction of each channel, the mobile terminal 1 can always emit the sound of each channel from an appropriate speaker to improve the sound image localization by always setting the virtual speaker in the optimal direction by the panning processing using the plurality of speakers.

### Fourth Modification

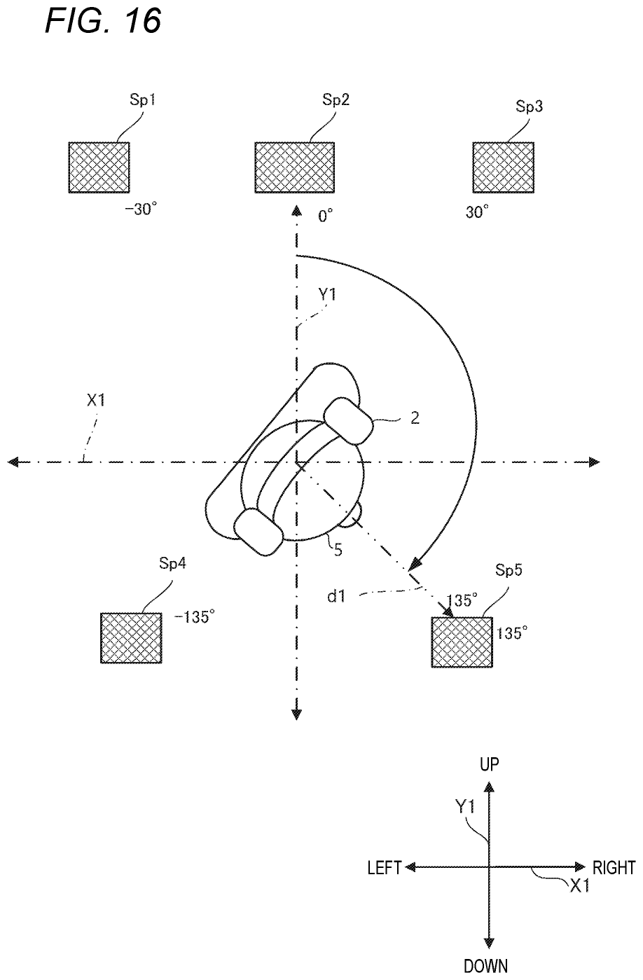

The audio system 100B according to the fourth modification automatically determines the speaker in the center direction by combining the mobile terminal 1D provided with the center direction detection unit 166 and the head tracking function described in the second modification, and the automatic detection function for the speaker location in the third modification. The audio system 100B according to the fourth modification will be described with reference to FIG. 16. FIG. 16 is an explanatory diagram of the audio system 100B according to the fourth modification, in which the user 5 and the speaker Sp1, the speaker Sp2, the speaker Sp3, the speaker Sp4, and the speaker Sp5 are viewed from the vertical direction (in a plan view). In FIG. 16, a direction indicated by an alternate long and short dash line in the left-right direction of the paper surface is defined as the left-right direction X2. In FIG. 16, a direction indicated by an alternate long and short dash line in the up-down direction of the paper surface is defined as the front-rear direction Y2. In FIG. 16, a direction indicated by a solid line in the left-right direction of the paper surface is defined as the left-right direction X1 in the space 4. In FIG. 16, a direction indicated by a solid line in the up-down direction of the paper surface is defined as the front-rear direction Y1.

FIG. 16 shows a case where the user 5 changes the direction of the head from looking to the front side (a front side in the front-rear direction Y1 and a center in the left-right direction X1) in the space 4 to looking diagonally to a rear right side (a rear side in the front-rear direction Y1 and a right side in the left-right direction X1). The direction the user 5 faces can be detected by the head tracking function. Here, the mobile terminal 1D stores a relative location of the speakers (a direction in which each speaker is installed) with respect to the listening position. For example, the mobile terminal 1D stores the installation direction of the speaker Sp2 as a front direction (0 degrees), the speaker Sp3 as 30 degrees, the speaker Sp5 as 135 degrees, the speaker Sp1 as −30 degrees, and the speaker Sp4 as −135 degrees. The user 5 taps an icon such as the “center reset” when facing the direction of the speaker Sp2, for example. As a result, the mobile terminal 1D determines the speaker Sp2 as the speaker in the center direction. In this case, the mobile terminal 1D sends an audio signal corresponding to the L channel to the speaker Sp1. The mobile terminal 1D sends an audio signal corresponding to the R channel to the speaker Sp3.

The mobile terminal 1D automatically determines the speaker in the center direction of the user 5 among the speaker Sp1, the speaker Sp2, the speaker Sp3, the speaker Sp4, and the speaker Sp5. For example, when the user 5 rotates 30 degrees to the right side in a plan view, the mobile terminal 1D changes the speaker in the center direction from the speaker Sp2 to the speaker Sp3. In this case, the mobile terminal 1D sends an audio signal corresponding to the center C channel to the speaker Sp3. The mobile terminal 1D sends the audio signal corresponding to the L channel to the speaker Sp2. The mobile terminal 1D sends the audio signal corresponding to the R channel to the speaker Sp5. The mobile terminal 1D may perform panning processing of distributing the audio signal corresponding to the R channel to the speaker Sp3 and the speaker Sp5 at a predetermined gain ratio. As a result, the mobile terminal 1D can set a virtual speaker in a direction of 30 degrees to the right side of the user 5 and make the sound of the R channel come from the direction of 30 degrees to the right side.

In the example shown in FIG. 16, the user 5 faces a direction rotated 135 degrees to the right side in a plan view. The center direction of the user 5 shown in FIG. 16 is shown as a direction dl. In this case, the speaker Sp5 is installed in the center direction of the user 5. Therefore, the mobile terminal 1D changes the speaker in the center direction from the speaker Sp3 to the speaker Sp5. The mobile terminal 1D sends the audio signal corresponding to the center C channel to the speaker Sp5. The mobile terminal 1D performs the panning processing of distributing the audio signal corresponding to the R channel to the speaker Sp5 and the speaker Sp4 at a predetermined gain ratio. As a result, the mobile terminal 1D can set a virtual speaker in the direction of 30 degrees to the right side of the user 5 and make the sound of the R channel come from the direction of 30 degrees to the right side. The mobile terminal 1D performs the panning processing of distributing the audio signal corresponding to the L channel to the speaker Sp5 and the speaker Sp3 at a predetermined gain ratio. As a result, the mobile terminal 1D can set a virtual speaker in a direction of 30 degrees to the left side of the user 5 and make the sound of the L channel come from the direction of 30 degrees to the left side.

That is, the mobile terminal 1D periodically determines a speaker that matches the direction the user 5 faces, and when it is determined that the speaker installed in the center direction of the user 5 becomes a different speaker, the speaker in the center direction is changed to a different speaker, and the audio signal corresponding to the center C channel is sent to the changed speaker.

When the center direction of the user 5 faces between a plurality of speakers, the mobile terminal 1D uses one of the two speakers installed with the center direction of the user 5 sandwiched therebetween as the speaker in the center direction. Alternatively, when the center direction of the user 5 faces between a plurality of speakers, the mobile terminal 1D may perform the panning processing of distributing the audio signal of the center C channel with a predetermined gain ratio to each of the two speakers installed with the center direction of the user 5 sandwiched therebetween, and may set a virtual speaker in the center direction.

In this way, when the center direction of the user 5 and the direction of the speaker match with each other, the mobile terminal 1D sends the audio signal corresponding to the center C channel to the speaker in the direction with which the center direction of the user 5 matches. When the center direction of the user 5 faces between the speakers, the mobile terminal 1D may distribute the audio signal to the plurality of speakers near the center direction. As a result, the mobile terminal 1D can set so that the speaker always exists in the center direction of the user 5, and can make the sound reach from the front side of the user 5.

As described above, the mobile terminal 1D according to the fourth modification can automatically determine the speaker in the center direction according to the movement of the user 5 by using the head tracking function and the automatic detection function for the speaker location.

### Fifth Modification

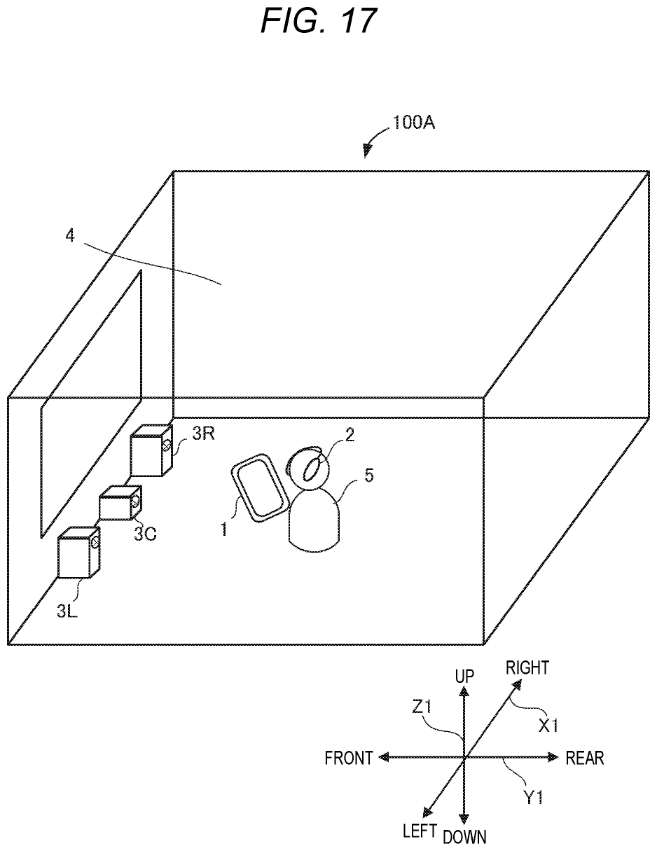

An audio system 100A according to the fifth embodiment sends an audio signal to a plurality of speakers. The audio system 100A according to the fifth modification will be described with reference to FIG. 17. FIG. 17 is a schematic diagram showing the space 4 in which the audio system 100A according to the fifth modification is used. In this embodiment, a speaker 3L, a speaker 3R, and a speaker 3C are used. As shown in FIG. 17, the user 5 listens to the content facing the front side of the space 4 (the front side in the front-rear direction Y1). The same components as those in the first embodiment are designated by the same reference numerals, and detailed description thereof will be omitted. Since the speaker 3L and the speaker 3R have the same configuration and function as the speaker 3 described above, detailed description thereof will be omitted.

For example, when the mobile terminal 1 is connected to the three speakers (the speaker 3L, the speaker 3R, and the speaker 3C) in the front side of the space 4, each of the three speakers emits sound. More specifically, the mobile terminal 1 associates all the channels corresponding to the locations that are in front of the top of the head of the user 5 with the plurality of speakers (in this embodiment, the speaker 3L, the speaker 3R, and the speaker 3C). Then, the mobile terminal 1 emits sound related to each of all the channels corresponding to the locations being in front of the top of the head from the corresponding speaker. In this embodiment, the mobile terminal 1 sends the audio signal corresponding to the L channel to the speaker 3L. The mobile terminal 1 sends the audio signal corresponding to the R channel to the speaker 3R. The mobile terminal 1 sends the audio signal corresponding to the center C channel to a center C speaker.

In the audio system 100A according to the fifth embodiment, all the channels corresponding to the locations that are in front of the top of the head are associated with the plurality of speakers (in this embodiment, the speaker 3L, the speaker 3R, and the speaker 3C), and the audio signal of each channel is output to the plurality of speakers. As a result, the audio system 100A can more accurately localize the sound image by compensating for the sense of localization with the plurality of speakers corresponding to the locations in front of the top of the head. Therefore, in the audio system 100A, the sound image localization is further improved when the headphone 2 is used.

### Sixth Modification

The mobile terminal 1 according to the sixth modification sends to the speaker 3 the audio signal corresponding to the center C channel corresponding to the location that is in front of the top of the head of the user 5, and outputs to the headphone 2 the audio signals corresponding to the L channel, the R channel, the rear L channel, and the rear R channel, among the plurality of channels.

The localization processing unit 162 gives the head-related transfer function for localizing a sound image to a location determined for each channel to the audio signals corresponding to the L channel, the R channel, the rear L channel, and the rear R channel. Here, regarding the center C channel, since the audio signal corresponding to the center C channel is sent to the speaker 3, the sound image localization processing is not performed. The localization processing unit 162 generates an audio signal corresponding to the stereo L channel in which the head-related transfer functions from the locations (see FIG. 2) of the virtual speakers FL, FR, RL, and RR to the left ear are convoluted, and an audio signal corresponding to the stereo R channel in which the head-related transfer functions from the locations (see FIG. 2) of the virtual speakers FL, FR, RL, and RR to the right ear are convoluted.

The audio signal control unit 163 outputs a stereo signal including the audio signal corresponding to the stereo L channel and the audio signal corresponding to the stereo R channel after the sound image localization processing by the localization processing unit 162, to the headphone 2 via the communication unit 15.

As a result, the mobile terminal 1 reduces a phenomenon that the virtual speaker C existing in the region A1 is perceived at the location of the headphone (head) 2, and the sound related to the center C channel emitted from the speaker 3 can be perceived. Therefore, the user 5 can more strongly recognize the sense of distance from the sound related to the C channel. Therefore, the mobile terminal 1 can improve the sound image localization in a direction in which it is difficult for the user 5 to localize the sound image when the headphone 2 is used.

### Other Modifications

Speakers used in the audio system are not limited to fixed speakers arranged in the space 4. The speaker may be, for example, a speaker attached to the mobile terminal 1. The speaker may be, a mobile speaker, a PC speaker, and the like.

In the above embodiments, examples of sending the audio signal by wireless communication are described, but the present invention is not limited thereto. The mobile terminals 1, 1A, 1B, 1C, and 1D may send the audio signal to the speaker or the headphone using wired communication. In this case, the mobile terminals 1, 1A, 1B, 1C, and 1D may send an analog signal to the speaker or the headphone.

In the above embodiments, an example of 5 channels is described, but the present invention is not limited thereto. For the audio data, an audio system that supports surround, such as 3-channel, 5.1-channel, and 7.1-channel, can exhibit the effect of improving sound image localization in a direction in which the sound image localization is difficult for the user 5.

When the speaker 3 emits the sound related to the audio signal corresponding to the center C channel, the headphone 2 also emits sound based on the audio signal corresponding to the center C channel after the sound image localization processing.

Finally, the description of the embodiments should be considered as exemplary in all respects and not restrictive. The scope of the present invention is shown not by the above embodiments but by the scope of claims. The scope of the present invention includes the scope equivalent to the scope of claims.

What is claimed is:

1. An audio signal output method comprising:
acquiring audio data including a plurality of audio signals corresponding respectively to a plurality of channels;
applying a head-related transfer function, which localizes a sound image to a location determined for each of the plurality of channels to each of the plurality of audio signals;
outputting first audio signals that have been applied with the head-related transfer functions, among the plurality of audio signals, to an earphone; and
outputting the audio signal of one channel corresponding to a location that is in front of a top of a listener's head, among the plurality of audio signals, to a speaker.

2. The audio signal output method according to claim 1, wherein the one channel corresponding to the location comprises a center channel.

3. The audio signal output method according to claim 2, further comprising:
receiving operation of selecting the speaker, which corresponds to a center speaker corresponding to the center channel; and
outputting the audio signal corresponding to the center channel to the the center speaker based on the operation.

4. The audio signal output method according to claim 1, further comprising:
detecting a center direction that faces the listener; and
determining the speaker, from among a plurality of speakers, that receives the audio signal based on the detected center direction.

5. The audio signal output method according to claim 4, wherein the detecting detects the center direction using a head tracking function.

6. The audio signal output method according to claim 1, wherein each of the plurality of audio signals is output to the corresponding speaker among a plurality of the speakers.

7. The audio signal output method according to claim 1, further comprising:
acquiring speaker location information of the speaker; and
performing signal processing of adjusting an output timing of the audio signal to be output to the earphone based on the speaker location information.

8. The audio signal output method according to claim 7, wherein the speaker location information is acquired by measurement.

9. The audio signal output method according to claim 1, wherein the first audio signals output to the earphone correspond to other channels, among the plurality of channels, different from the one channel.

10. An audio signal output device comprising:
a memory storing instructions;
a processor that implements the instructions to
acquire audio data including a plurality of audio signals corresponding respectively to a plurality of channels;
apply a head-related transfer function, which localizes a sound image to a location determined for each of the plurality of channels, to each of the plurality of audio signals;
output first audio signals that have been applied with the head-related transfer functions, among the plurality of audio signals, to an earphone; and
output the audio signal of one channel corresponding to a location that is in front of a top of a listener's head, among the plurality of audio signals, to a speaker.

11. The audio signal output device according to claim 10, wherein the one channel corresponding to the location comprises a center channel.

12. The audio signal output device according to claim 11, further comprising:
a user interface that receives operation of selecting the speaker, which corresponds to a center speaker corresponding to the center channel.

13. The audio signal output device according to claim 10, wherein the processor implements the instructions to:
detect a center direction that faces the listener; and
determine the speaker, from among a plurality of speakers, that receives the audio signal based on the detected center direction.

14. The audio signal output device according to claim 13, wherein the processor detects the center direction using a head tracking function.

15. The audio signal output device according to claim 10, wherein each of the plurality of audio signals is output to the corresponding speaker among a plurality of the speakers.

16. The audio signal output device according to claim 10, wherein the processor implements the instructions to:
acquire speaker location information of the speaker; and
perform signal processing of adjusting an output timing of the audio signal to be output to the earphone based on the speaker location information.

17. The audio signal output device according to claim 16, wherein the speaker location information is acquired by measurement.

18. The audio signal output device according to claim 10, wherein the first audio signals output to the earphone correspond to other channels, among the plurality of channels, different from the one channel.

19. An audio system comprising:
an earphone;
a speaker; and
an audio signal output device comprising:
a memory storing instructions;
a processor that implements the instructions to:
acquire audio data including a plurality of audio signals corresponding respectively to a plurality of channels;
apply a head-related transfer function, which localizes a sound image to a location determined for each of the plurality of channels, to each of the plurality of audio signals;
output first audio signals that have been applied with the head-related transfer functions, among the plurality of audio signals, to the earphone; and
output the audio signal of one channel corresponding to a location that is in front of a top of a listener's head, among the plurality of audio signals, to the speaker,
wherein the earphone comprises:
a first communication unit that receives the plurality of audio signals from the audio signal output device; and
a first sound emitting unit that emits sound based on the audio signal; and
wherein the speaker comprises:
a second communication unit that receives the audio signal from the audio signal output device; and
a second sound emitting unit that emits the audio signal.
